(19) United States
(12) Patent Application Publication
(10) Pub. No.: US 2018/0025312 A1
(43) Pub. Date: Jan. 25, 2018

(54) SYSTEMS AND METHODS FOR SHARING INFORMATION ABOUT PRODUCT MATERIALS

(71) Applicant: Quanta Computer Inc., Taoyuan City (TW)

(72) Inventors: Tien-Chin FANG, Taoyuan City (TW); Chen-Chung LEE, Taoyuan City (TW); Ping-Chi LAI, Taoyuan City (TW); Ching-Shium CHEN, Taoyuan City (TW); Chia-Hung LIN, Taoyuan City (TW); Yao-Kun LEE, Taoyuan City (TW); Jhen-Jhong CHEN, Taoyuan City (TW)

(21) Appl. No.: 15/341,129

(22) Filed: Nov. 2, 2016

(30) Foreign Application Priority Data
Jul. 25, 2016 (TW) 105123382

(51) Int. Cl. G06Q 10/08; G06F 17/30

(52) U.S. Cl. CPC G06Q 10/087; G06F 17/30864; G06Q 50/28

(57) ABSTRACT

A system for sharing information about product materials, including a database, a part-analyzing module, a part-searching module, and a disclosure-rate calculating module. The database includes a first sub-database corresponding to an enterprise and a second sub-database corresponding to a first supplier. The first sub-database stores information of a plurality of parts composing a product and information about the first supplier of the parts, and the second sub-database stores material information corresponding to the parts. The part-analyzing module obtains the information of the parts and the information about the first supplier from the first sub-database. The part-searching module obtains first disclosed material information and first undisclosed material information of the parts from the second sub-database. The disclosure-rate calculating module calculates the first disclosure rate of the product according to the first disclosed material information and the first undisclosed material information.

### CROSS REFERENCE TO RELATED APPLICATIONS

This application claims priority of Taiwan Patent Application No. 105123382, filed on Jul. 25, 2016, the entirety of which is incorporated by reference herein.

### BACKGROUND OF THE INVENTION

### Field of the Invention

The application relates in general to a system and a method for sharing information about product materials, and in particular to a system and a method for sharing information about product materials between the suppliers having a peer relationship.

### Description of the Related Art

Because of the demands of environmental protection, whether a product is able to get environmental certification or not has become an important issue. In the past, products were certified based on the material information supported by parts suppliers, to reduce the number of required certifications. However, a situation may occur in which parts suppliers lack some material information, or the parts suppliers are reluctant to provide said material information during the exchange of information, and this might delay the certification procedure. Thus, how to obtain the material information that is not disclosed by the part suppliers is a problem which needs to be solved immediately.

### BRIEF SUMMARY OF INVENTION

An embodiment of the present invention provides a system for sharing information about product materials, including a database, a part-analyzing module, a part-searching module, and a disclosure-rate calculating module. The database includes a first sub-database corresponding to an enterprise and a second sub-database corresponding to a first supplier. The first sub-database stores information of a plurality of parts composing a product and information about the first supplier supporting the parts, and the second sub-database stores material information corresponding to the parts. The part-analyzing module obtains the information of the parts and the information about the first supplier from the first sub-database. The part-searching module obtains first disclosed material information of the parts and first undisclosed material information of the parts from the second sub-database. The disclosure-rate calculating module calculates the first disclosure rate of the product according to the first disclosed material information and the first undisclosed material information.

Another embodiment of the present invention provides a method for sharing information about product materials, including: creating a database, wherein the database comprises a first sub-database corresponding to an enterprise and a second sub-database corresponding to a first supplier, the first sub-database stores information of a plurality of parts composing a product and information about the first supplier supporting the parts, and the second sub-database stores material information corresponding to the parts; obtaining, via a part-analyzing module, the information of the parts and the information about the first supplier from the first sub-database; obtaining, via a part-searching module, first disclosed material information of the parts and first undisclosed material information of the parts from the second sub-database; and, calculating, via a disclosure-rate calculating module, the first disclosure rate of the product according to the first disclosed material information and the first undisclosed material information.

### BRIEF DESCRIPTION OF DRAWINGS

The invention can be more fully understood by reading the subsequent detailed description and examples with references made to the accompanying drawings, wherein:

FIG. 1 illustrates a block diagram of the system for sharing the information of the product materials in accordance with an embodiment of the invention.

FIG. 2 illustrates a block diagram of the peer relationship between the suppliers in accordance with an embodiment of the invention.

FIG. 3 illustrates a flow chart of the method for sharing the information of the product materials in accordance with an embodiment of the invention.

### DETAILED DESCRIPTION OF INVENTION

Further areas to which the present system and method for sharing the information of the product materials can be applied will become apparent from the detailed description provided herein. It should be understood that the detailed description and specific examples, while indicating exemplary embodiments of a system and a method for sharing the information of the product materials, are intended for the purposes of illustration only and are not intended to limit the scope of the invention.

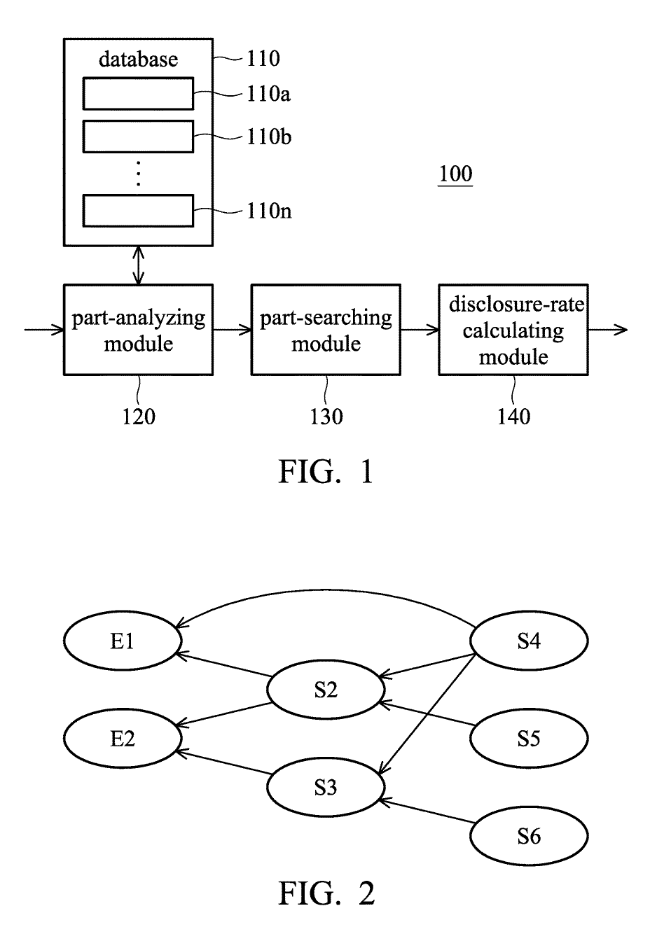

Please refer to FIG. 1. FIG. 1 illustrates a block diagram of the system 100 for sharing the information of the product materials in accordance with an embodiment of the invention. The system 100 includes a database 110, a part-analyzing module 120, a part-searching module 130, and a disclosure-rate calculating module 140. The database 110 can be cloud spaces, such as Dropbox, Google Drive, iCloud, One Drive, etc., or another storage medium, such as RAM, flash memory, ROM, EPROM, EEPROM, register, hard disk, removable disk, CD-ROM, or another storage medium, which is used to store part information of different products, material information of different parts, information about the suppliers, and information of peer relationship between various suppliers, etc. In addition, the database 110 further includes a plurality of sub-databases 110a-110n. Each sub-database 110a-110n corresponds to different parts suppliers, and is used to store the disclosed material information of the parts supplied by the corresponding parts suppliers. The part-analyzing module 120 analyzes a product composition. The part-searching module 130 searches the material information of the parts of the product. The disclosure-rate calculating module 140 calculates the disclosure rate of the product according to the disclosed material information and the undisclosed material information.

TABLE 1

| product | part | material |
|---|---|---|
| A | P1 | M1 |
| | | M2 |
| | | M3 |
| | P2 | M4 |
| | | M5 |
| | P3 | M6 |
| | | M7 |
| | | M8 |

Please refer to Table 1. Table 1 illustrates the parts contained in product “A” and material information of the corresponding parts. When the user wants to calculate the disclosure rate of product “A”, the user may input the product name or product ID of product “A” to the part-analyzing module 120 through an operation interface, such as a user interface. The part-analyzing module 120 then obtains the part information of product “A” from the sub-database corresponding to enterprise “E1” that sells product “A” according to the product name or the product ID. In an embodiment of the present invention, the part-analyzing module 120 analyzes that product “A” is composed of part “P1”, part “P2”, and part “P3”. Since enterprise “E1” may already store the material information of some or all of the parts of product “A”, the part-searching module 130 may confirm whether all material information of part “P1”, part “P2”, and part “3” is stored in the sub-database corresponding to enterprise “E1”. If the part-searching module 130 obtains all material information of product “A” from the sub-database of enterprise “E1”, the disclosure-rate calculating module 140 may obtain a disclosure rate of 8/8=100% according to the search result, and display all information of materials “M1” to “M8” on the user interface.

Otherwise, if the sub-database corresponding to enterprise “E1” does not store any material information of the parts, or only stores the material information of some of the parts of product “A”, the part-searching module 130 may have to obtain the supplier's information of the undisclosed parts of product “A” from the sub-database corresponding to enterprise “C1”, and then search the material information of the undisclosed material from other sub-databases of the corresponding suppliers for increasing the disclosure rate of product “A”. Each supplier can set an access authority of the material information for the corresponding sub-database, such as an access authority that corresponds to the information of each material, or an access authority for different enterprises. For example, when the sub-database of enterprise “E1” only stores the material information of part “P1”, supplier “S2” that supplies part “P2” does not disclose the material information of material “M4” or does not support the access authority of material “M4” for enterprise “E1”, and supplier “S3” that supplies part “P3” also limits the access authority of material “M6”, the part-searching module 130 finally only obtains the material information of materials “M1” to “M3”, “M5”, “M7”, and “M8”. The disclosure-rate calculating module 140 then obtains a disclosure rate of 6/8=75%. In contrast, when both supplier “S2” that supports part “P2” and supplier “S3” that supports part “P3” do not limit the access authority of the material information of part “P2” and part “P3”, the part-searching module 130 may obtain all material information of materials “M1” to “M8”. The disclosure-rate calculating module 140 then obtains a disclosure rate of 8/8=100%. The limitation of access authority of the material means that the supplier only discloses the name of the material rather than other details, such as weight percentage or density of the material.

According to another embodiment, since enterprise “E1” may have a peer relationship with the parts suppliers that supply the parts, the part-searching module 130 may obtain the material information of part “P2” and part “P3” from the sub-database of supplier “S2” and supplier “S3”, or the sub-database of other suppliers having peer relationships with enterprise “E1”, such as suppliers “S4”, “S5”, and “S6” that support the material producing part “P2” or part “P3”. For example, FIG. 2 illustrates a block diagram of the peer relationships of the suppliers in accordance with an embodiment of the invention. As shown in FIG. 2, supplier “S2” obtains a portion of material from supplier “S4” and supplier “S5”, supplier “S4” has a peer relationship with enterprise “E1”, and supplier “S3” obtains a portion of material from supplier “S4” and supplier “S6”. When the part-searching module 130 fails to obtain the material information of materials “M4” and “M6” from the sub-databases of suppliers “S2” and “S3”, the part-searching module 130 may obtain the information of the peer relationship between various suppliers from the sub-database of enterprise “E1”, and may try to obtain the material information of material “M4” from supplier “S4” according to the information of the peer relationship. For example, as shown in FIG. 2, supplier “S4” has a peer relationship with enterprise “E1”, which means that enterprise “E1” can access the material information of the parts from the sub-database of supplier “S4”. If the sub-database of supplier “S4” allows the part-searching module 130 to access the material information of material “M4”, the disclosure rate of product “A” may increase to 7/8=87.5%.

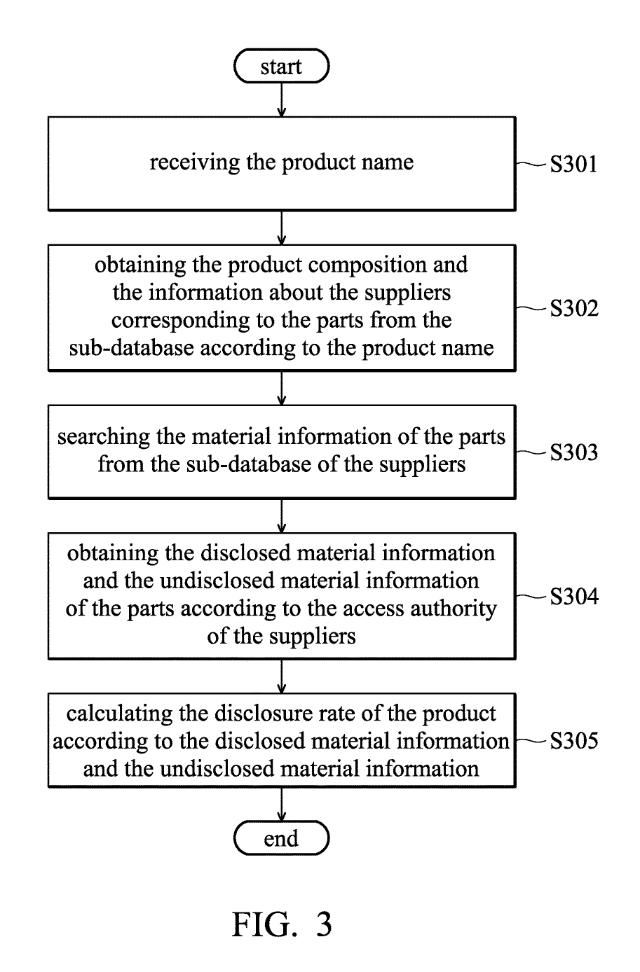

FIG. 3 illustrates a flow chart of the method for sharing the information of the product materials in accordance with an embodiment of the invention. In step S301, the part-analyzing module 120 receives the product name. In step S302, the part-analyzing module 120 obtains the product composition and the information about the suppliers corresponding to the plurality of parts from the sub-database corresponding to the product according to the product name. In step S303, the part-searching module 130 searches the material information of the parts from the sub-database of the suppliers. In step S304, the part-searching module 130 obtains the disclosed material information and the undisclosed material information of the parts according to the access authority of the suppliers. In step S305, the disclosure-rate calculating module 140 calculates the disclosure rate of the product according to the disclosed material information and the undisclosed material information.

As described above, according to the system and method for sharing information about product materials of the present invention, in a situation where part suppliers fail to disclose material information of all parts, the enterprise may able to search the undisclosed material information of the parts from other sub-databases corresponding to material suppliers having a peer relationship with the enterprise for increasing the disclosure rate of the product.

It should be noted that the functions of the various modules described herein may be implemented in hardware, software, firmware or combination thereof. If implemented in software, the functions can be stored on or transmitted over as one or more instructions or code on a non-transitory computer-readable medium. The instructions or the code may be, for example, binaries, intermediate format instructions such as assembly language, firmware, or source code. The instructions or the code can be accessed and executed by a processor, and the implemented results can be displayed through a user interface on a screen.

It will be apparent to those skilled in the art that various modifications and variations can be made to the structure disclosed without departing from the scope or spirit of the invention. In view of the foregoing, it is intended that the present invention covers modifications and variations of this invention, provided they fall within the scope of the following claims and their equivalents.

What is claimed is:

1. A system for sharing information about product materials, comprising:
a database, comprising a first sub-database corresponding to an enterprise and a second sub-database corresponding to a first supplier, wherein the first sub-database stores information of a plurality of parts composing a product and information about the first supplier supporting the parts, and the second sub-database stores material information corresponding to the parts;
a part-analyzing module, obtaining the information of the parts and the information about the first supplier from the first sub-database;
a part-searching module, obtaining first disclosed material information and first undisclosed material information of the parts from the second sub-database; and
a disclosure-rate calculating module, calculating a first disclosure rate of the product according to the first disclosed material information and the first undisclosed material information.

2. The system as claimed in claim 1, wherein the part-searching module further obtains the first disclosed material information and the first undisclosed material information from the second sub-database according to a first access authority.

3. The system as claimed in claim 1, wherein the database further comprises a third sub-database, configured to store second disclosed material information and second undisclosed material information of the first undisclosed material information, and a second supplier corresponding to the third sub-database has a peer relationship with the enterprise.

4. The system as claimed in claim 3, wherein the disclosure-rate calculating module further calculates a second disclosure rate of the product according to the first disclosed material information, the second disclosed material information, and the second undisclosed material information.

5. The system as claimed in claim 4, wherein the part-searching module further obtains the second disclosed material information and the second undisclosed material information from the third sub-database according to a second access authority.

6. A method for sharing information about product materials, comprising:
creating a database, wherein the database comprises a first sub-database corresponding to an enterprise and a second sub-database corresponding to a first supplier, the first sub-database stores information of a plurality of parts composing a product and information about the first supplier supporting the parts, and the second sub-database stores material information corresponding to the parts;
obtaining, via a part-analyzing module, the information of the parts and the information about the first supplier from the first sub-database;
obtaining, via a part-searching module, first disclosed material information and first undisclosed material information of the parts from the second sub-database; and
calculating, via a disclosure-rate calculating module, a first disclosure rate of the product according to the first disclosed material information and the first undisclosed material information.

7. The method as claimed in claim 6, wherein the step of obtaining the first disclosed material information of the parts and the first undisclosed material information of the parts further comprises:
obtaining, via the part-searching module, the first disclosed material information and the first undisclosed material information from the second sub-database according to a first access authority.

8. The method as claimed in claim 6, wherein the database further comprises a third sub-database, configured to store second disclosed material information and second undisclosed material information of the first undisclosed material information, and a second supplier corresponding to the third sub-database has a peer relationship with the enterprise.

9. The method as claimed in claim 8, further comprising:
calculating, via the disclosure-rate calculating module, a second disclosure rate of the product according to the first disclosed material information, the second disclosed material information, and the second undisclosed material information.

10. The method as claimed in claim 9, further comprising:
obtaining, via the part-searching module, the second disclosed material information and the second undisclosed material information from the third sub-database according to a second access authority.
